(19) United States
(12) Patent Application Publication
(10) Pub. No.: US 2014/0339838 A1
(43) Pub. Date: Nov. 20, 2014

(54) YARD CADDY

(71) Applicant: Troy Ferrari, Las Vegas, NV (US)

(72) Inventor: Troy Ferrari, Las Vegas, NV (US)

(21) Appl. No.: 13/897,486

(22) Filed: May 20, 2013

(51) Int. Cl. A01K 23/00

(52) U.S. Cl. CPC A01K 23/005
USPC 294/1.3

(57) ABSTRACT

A yard caddy is disclosed. In an embodiment, the yard caddy is configured as a pet feces removal device. The yard caddy or pet feces removal device includes a blower motor assembly, a blower motor handle, an extended handle and a blower duct. The extended handle is connected via a coupling to a net frame assembly. A mesh net is attached to the net frame assembly. The blower duct is configured such that the output of the blower duct is proximal the net frame assembly. In use, a user located the pet feces removal device, such that pet feces are located between the output of the blower duct and the net frame assembly. The blower motor is then turned-on. Compressed air from an impeller/fan blade/compressor wheel driven by the blower motor assembly exits the output of the blower duct where it is directed at the pet feces. The pet feces are then blown into the mesh net. The pet feces may then be transported in the mesh net until being disposed of.

### RELATED APPLICATIONS

There are no related applications for this application.

### FIELD

The field of the invention relates generally to devices utilized for collection of pet or animal feces.

### BRIEF DESCRIPTION

A yard caddy for removal of pet feces is disclosed. The yard caddy in an embodiment is configured as a pet feces removal device. The yard caddy, or pet feces removal device comprises a blower motor assembly, an extended handle extending in a direction away from the blower motor assembly in some embodiments and a blower duct extending in a direction away from the blower motor. A coupling is attached to an end of the extended handle distal to the blower motor assembly in some embodiments. Also, a net frame assembly is attached to an end of the coupling opposite from the end where the extended handle is connected to the end of the coupling assembly and a net is attached to the coupling frame assembly.

Additionally, in some embodiments, the blower duct has a tapered portion, the tapered portion becomes narrower as the distance of the blower duct from the blower motor assembly becomes greater. The end of the blower duct terminates in a flattened portion at the output of the blower duct.

In use, a user locates the net frame assembly and the output of the blower duct of pet feces removal device on opposing sides of the pet feces to be removed. The motor is then turned-on. Once the motor is turned-on, output air from an impeller/compressor wheel/fan blade driven by the motor is discharged through the output of the blower duct. The mass flow and velocity of the air flowing through the output of the blower duct causes the pet feces to be displaced into the net of the pet feces removal device. Once the pet feces have been displaced into the net of the pet feces removal device, the pet feces may be transported in the net of the pet feces removal device until the pet feces may be disposed of. In some embodiments, a quick disconnect assembly allows the net frame assembly to be disconnected from the extended handle to facilitate disposal of the pet feces.

### BRIEF DESCRIPTION OF THE DRAWINGS

FIG. 1 is a front view of an embodiment of the pet feces removal device illustrating the assembly of the device, according to an implementation;

FIG. 2 is a front view of one embodiment of the pet feces removal device illustrating the assembly of the device, according to one implementation;

FIG. 3 is a front view of another embodiment of the pet feces removal device illustrating the assembly of the device, according to another implementation;

FIG. 4 is a side view of another embodiment of the pet feces removal device illustrating the assembly of the device, according to another implementation;

FIG. 5 is a detail view of the connection of the extended handle, coupling and net frame assembly, according to an implementation; and

FIG. 6 is a cross-sectional view of FIG. 5, according to an implementation.

### DETAILED DESCRIPTION

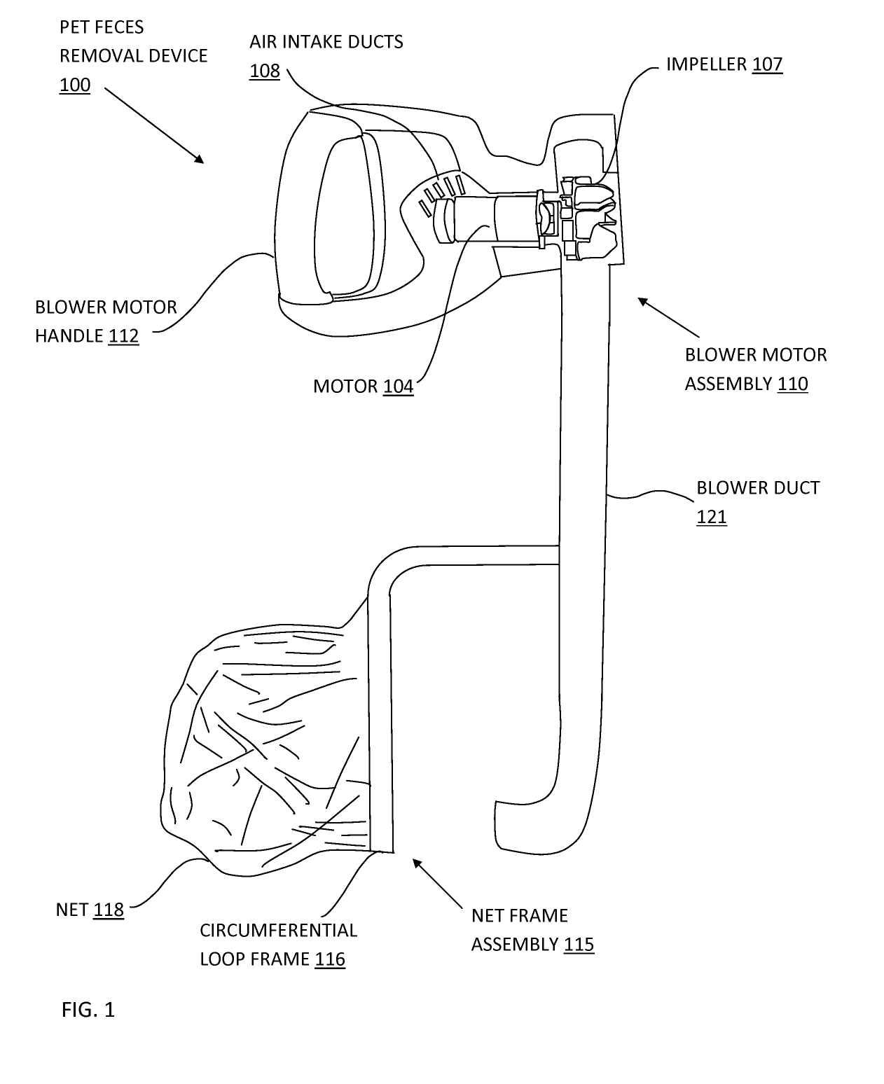

FIG. 1 is a front view of an embodiment of the pet feces removal device 100 for removal of pet feces illustrating the assembly of the pet feces removal device 100. As illustrated on FIG. 1, the pet feces removal device 100 includes a blower motor assembly 110. The blower motor assembly 110 includes a blower motor 104, an impeller, compressor wheel or fan blade 107, air intake ducts 108, a blower motor handle 112, a net frame assembly 115, a circumferential loop frame 116, a net 118 and a blower duct 121. The blower motor 104 may drive the impeller 107 directly, or through reduction gears. In one embodiment, the net frame assembly 115 is attached to the blower duct 121. However, the invention is not limited to this method of attachment.

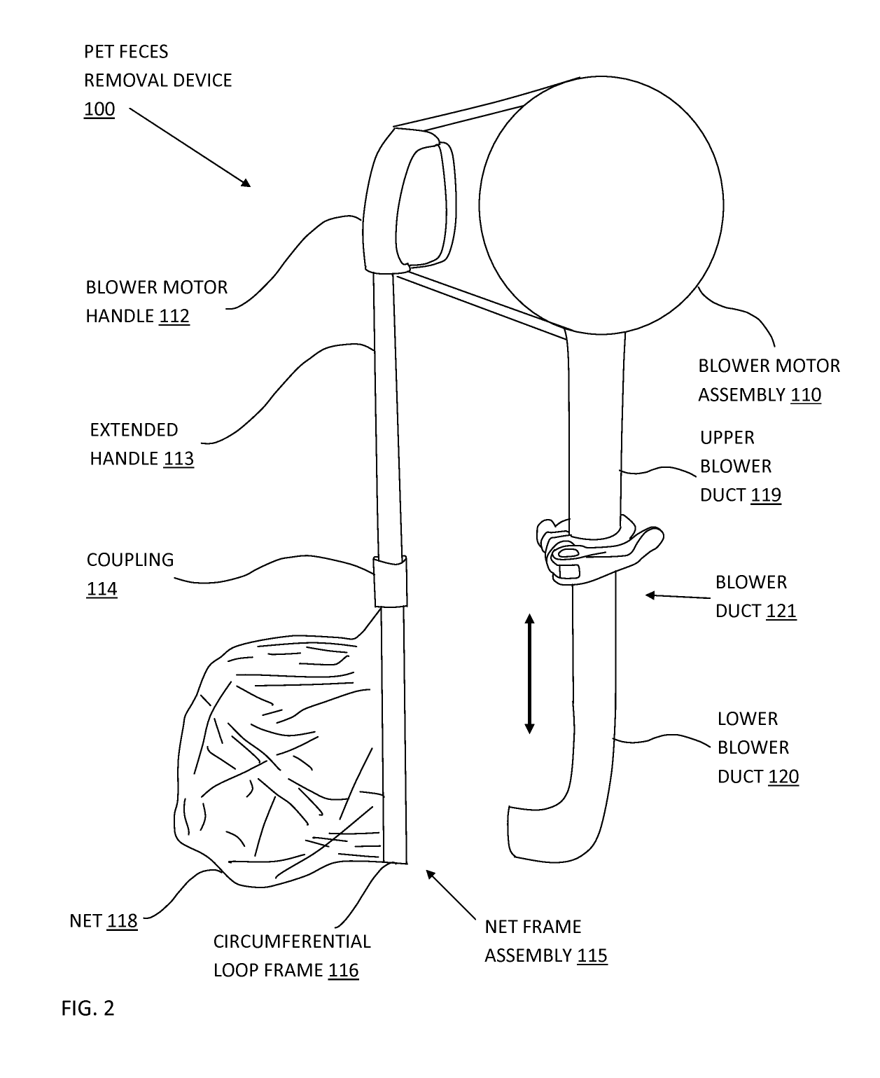

FIG. 2 is a front view of one embodiment of the pet feces removal device 100 illustrating the assembly of the pet feces removal device 100. As illustrated on FIG. 2, the pet feces removal device 100 includes the blower motor assembly 110, the blower motor handle 112, an extended handle 113, a coupling 114, the net frame assembly 115, the circumferential loop frame 116, the net 118 and the blower duct 121. In one embodiment, the net 118 is of a mesh pattern to facilitate washing feces remains from the net after the feces is discarded from the net 118. It has also been found that the orientation of a bottom the output 123 of the blower duct 121 relative to an outer diameter of the circumferential loop frame 116 is important. If the orientation of a bottom the output 123 of the blower duct 121 relative to the outer diameter of the circumferential loop frame 116 is such that the air output of the output 123 of the blower duct 121 is too “low”, the air output from the output 123 blowing on the pet feces will be reduced by friction with the ground. If the orientation of a bottom of the output 123 of the blower duct 121 relative to an outer diameter of the circumferential loop frame 116 is such that the air output of the output 123 of the blower duct 121 is too “high”, the air output from the output 123 blowing on the pet feces will be reduced by some of the air blowing over the top of the pet feces. Since the above teaches that the orientation of the bottom of the output 123 of the blower duct 121 relative to the outer diameter of the circumferential is important to proper retrieval of the pet feces in the net frame assembly 115, in some embodiments, as illustrated on FIG. 2, a quick release (QR) cam lever 125 in conjunction with a lower blower duct 120 which is socket fit into an upper blower duct 119 is utilized. In use of this embodiment, the QR cam lever 125 is operated to a non-clamped position. The lower blower duct 120 is aligned as desired to the net frame assembly 115 by sliding the lower blower duct 120 up or down within the upper lower duct 119 as illustrated by the double arrow on FIG. 2. Once the desired alignment of the lower blower duct 120 to the net frame assembly 115 is achieved, the QR cam lever 125 is operated so that a clamping force is applied to the upper blower duct 119 and lower blower duct 120 such that relative movement between the upper blower duct 119 and lower blower duct 120 is not possible.

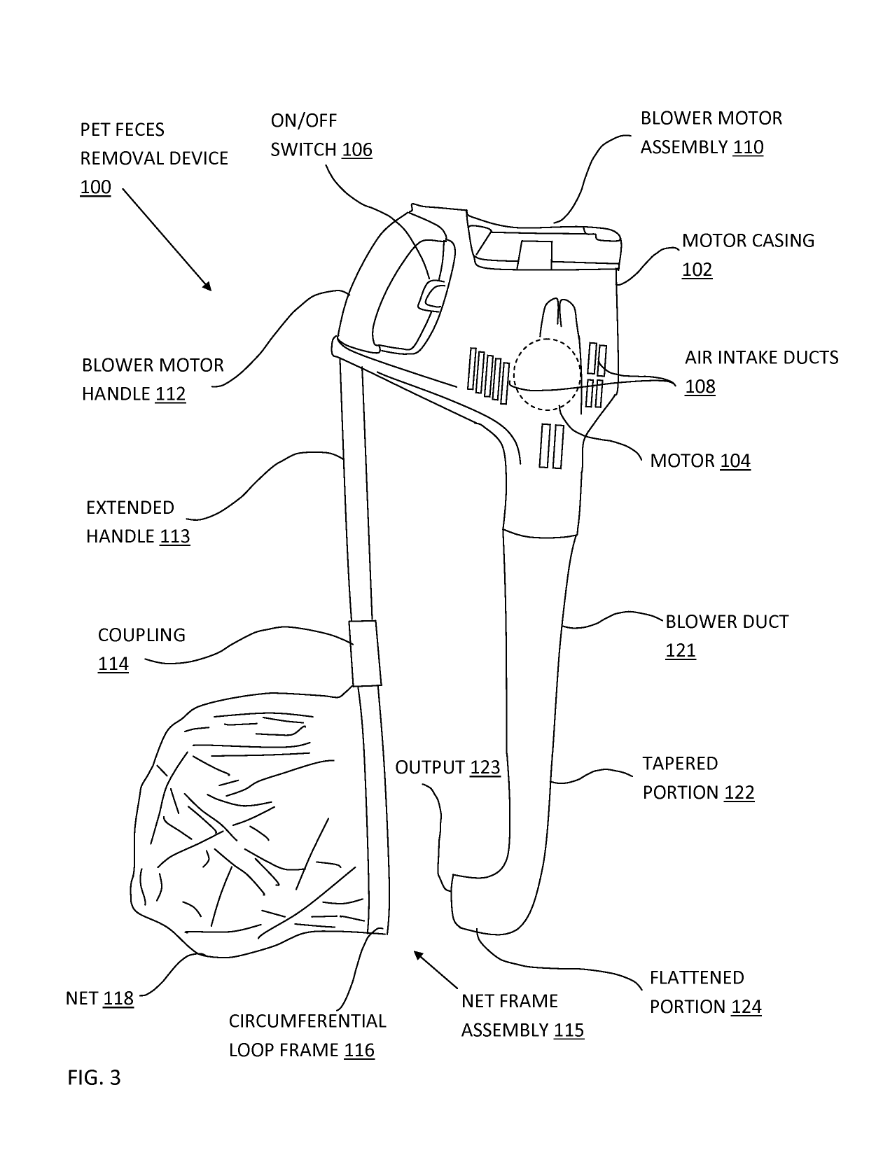

FIG. 3 is a front view of one embodiment of the pet feces removal device 100 illustrating the assembly of the device. As illustrated on FIG. 3, the pet feces removal device 100 includes a motor casing 102, a motor 104, an on/off switch 106 and air intake ducts 108. The motor 104 may be either driven by a gasoline engine, or a battery. However, the use of a battery powered motor 104 may be preferable, as the pet feces removal device 100 may only need to be operated for brief periods at a time for each use. The motor 104 drives an impeller 107 (FIG. 1). The impeller 107 output may be about 120 cubic feet per minute in this embodiment, but the invention is not limited to impeller air volume displacements in this range. The blower duct 121 as illustrated on FIG. 3 may be tapered 122 on the portion of the blower duct proximal the net 118. The tapered portion 122 allows air flow velocity to be increased over the wider portion of the blower duct 121 proximal the blower motor assembly 110. The output 123 of the blower duct 121 may have a flattened portion 124 to facilitate blowing air on a specific area where the pet feces is located. It has also been found that the distance between the net frame assembly 115 and the flattened portion 124 of the blower duct 121 is about 3 inches for maximum efficiency of moving the pet feces into the net 118. However, the invention is not limited to distances between the net frame assembly 115 and the flattened portion 124 of the blower duct 121 of about 3 inches.

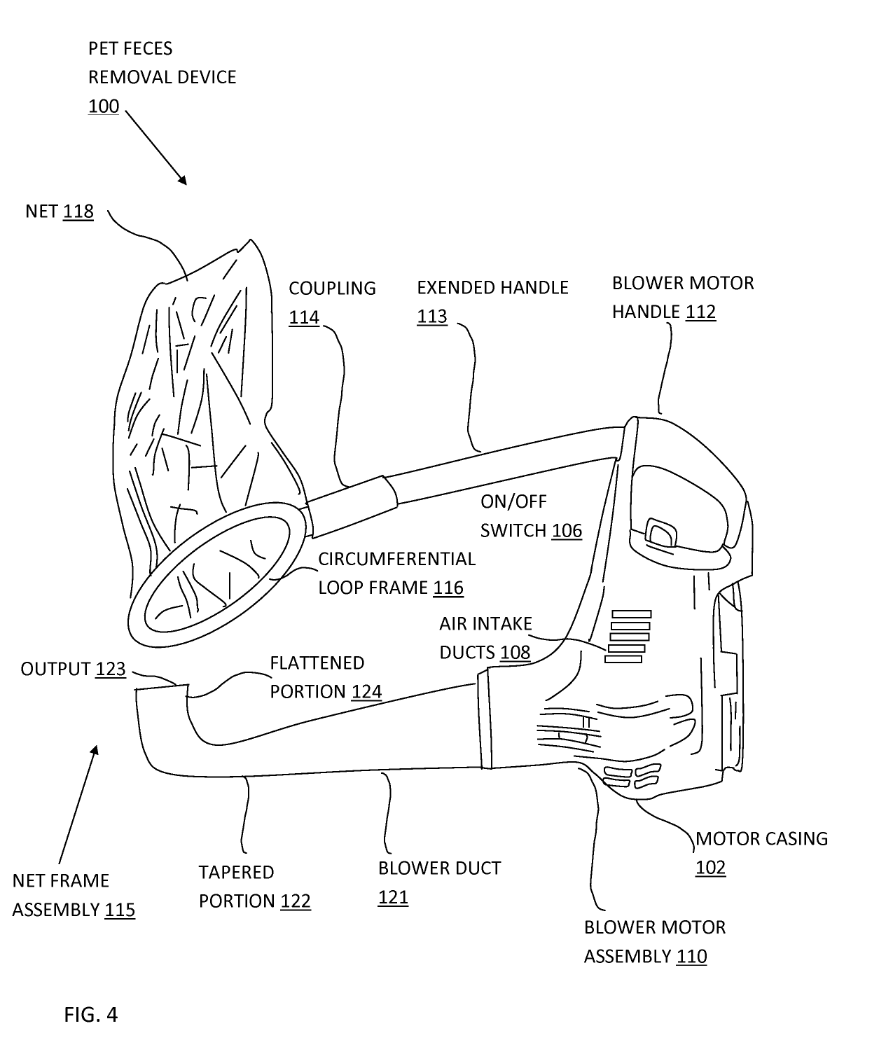

FIG. 4 is a side view of one embodiment of the pet feces removal device 100 further illustrating the assembly of the pet feces removal device 100. As illustrated on FIG. 4, the net frame assembly 115 includes a circumferential loop frame 116 on which the net 118 is mounted and a stub piece 117 which is rigidly attached to the circumferential loop frame 116. The stub piece 117 is also rigidly attached to the coupling 114. As also illustrated on FIG. 4, the coupling 114 is also attached to the extended handle 113.

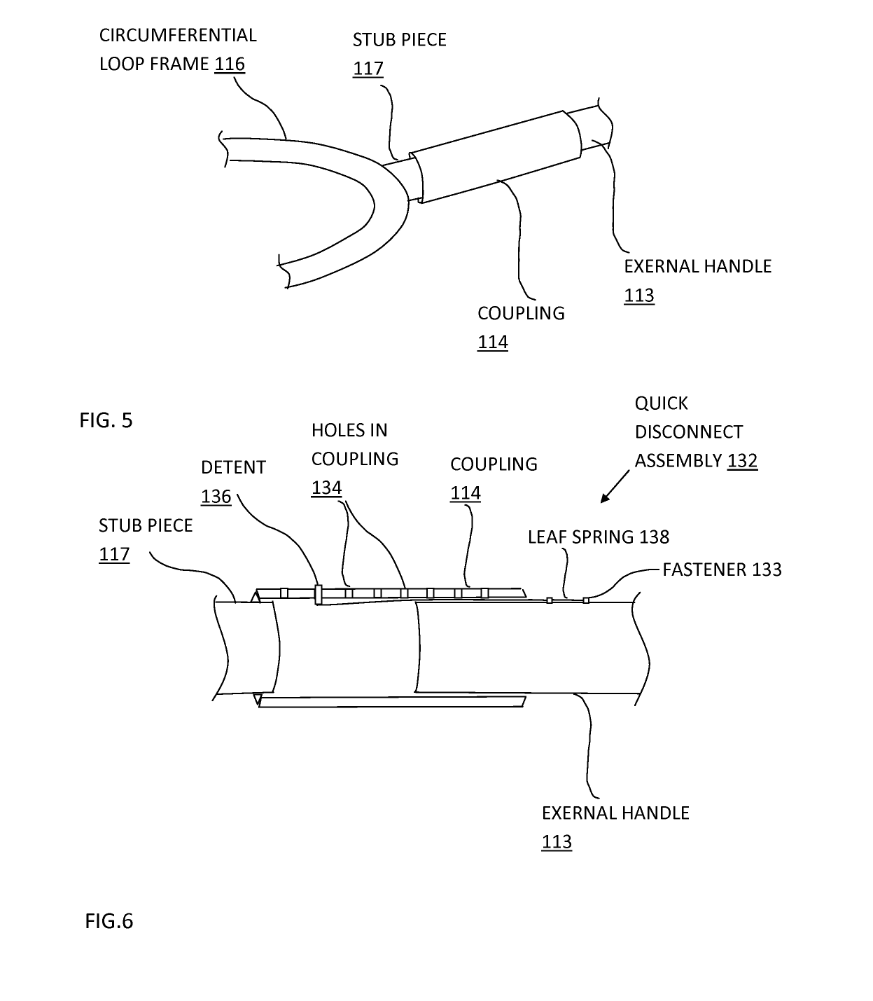

FIG. 5 is a detail view of the connection of the extended handle 113, the coupling 114 and the net frame assembly 115. As illustrated on FIG. 5, the stub piece 117 of the net frame assembly 115 and the extended handle 113 each have a socket fit to the coupling 114, which has a larger inner diameter than the outer diameters of the stub piece 117 and the extended handle 113. As illustrated on FIG. 4, the circumferential loop frame 116 of the net frame assembly 115 is rigidly secured to the stub piece 117. The method of rigidly securing the circumferential loop frame 116 to the stub piece 117 may include welding when metal parts may be utilized. The method of rigidly securing the circumferential loop 116 to the stub piece 117 may also include the use of adhesives, or thermoplastic welding when plastic parts may be utilized. However, the invention is not limited to these connection methods or these materials.

FIG. 6 is a cross-sectional view of FIG. 5. As illustrated in FIG. 6, the extended handle 113 is removably non-destructively attachable to the coupling 114 by use of a quick disconnect assembly 132. As illustrated on FIG. 6, the quick disconnect assembly 132 includes a leaf spring 138. One end of the leaf spring 138 is connected to the extended handle 113 by fasteners 133. On the other end of the leaf spring 138 is a detent 136. The detent 136 is inserted in one of a plurality of holes 134 in the coupling 114.

In use of the embodiment of FIGS. 1-6, a user locates the net frame assembly 115 and the output 123 of the blower duct of the pet feces removal device 100 on opposing sides of the pet feces to be removed. The on/off switch 106 is then toggled to the “on” position. Once the motor 104 is activated, output air from the impeller/fan blade/compressor wheel 107 is discharged through the output 123 of the blower duct 121. The mass flow and velocity of the air flowing through the output 123 of the blower duct 121 causes the pet feces to be displaced into the net 118 of the pet feces removal device 100. Once the pet feces has been displaced into the net 118 of the pet feces removal device 100, the pet feces may be transported in the net 118 of the pet feces removal device 100 until it may be disposed of. Disposal of the pet feces is facilitated by the quick disconnect assembly 132. The quick disconnect assembly 132 allows for the net frame assembly 115 to be removed from the pet feces removal device 100 to facilitate disposal of the pet feces. After disposal, any remaining pet feces remaining on the mesh net 118 may be removed by washing the mesh net 118 with a garden hose, or similar water source. After removal of the pet feces and washing of the net 118, the net frame assembly 115 is reinstalled to the pet feces removal device 100. The plurality of holes 134 in the coupling 114 in combination with the detent 136 allows the net frame assembly 115 to be installed such that a distance of the net frame assembly 115 to the extended handle 113 may be varied to further facilitate alignment of the blower duct 121 to the net frame assembly 115. Also, in a preferred embodiment of the pet feces removal device 100 utilizing a battery 105 powered motor 104, the battery 105 may be removed and recharged in a battery charger (not shown).

As a person skilled in the prior art will recognize after examination of the previous detailed description and the figures and claims, modifications and changes may be made to the preferred embodiments of the invention without departing from the scope of the invention as defined in the following claims.

1. A pet feces removal device comprising:
a blower motor assembly;
an extended handle extending in a direction away from the blower motor assembly;
a blower duct extending in a direction away from the blower motor;
wherein a coupling is attached to an end of the extended handle distal to the blower motor assembly, a net frame assembly is attached to an end of the coupling opposite from the end where the extended handle is connected to the end of the coupling and a net is attached to the coupling frame assembly.

2. The pet feces removal device of claim 1 wherein the blower motor assembly includes a blower motor handle.

3. The pet feces removal device of claim 1 wherein the blower motor assembly includes a blower motor powered by a battery.

4. The pet feces removal device of claim 3 wherein the battery is capable of being removed recharged and reinstalled.

5. The pet feces removal device of claim 1 wherein the blower duct includes a tapered portion and a flattened portion, the tapered portion becoming narrower in cross-section as the distance from the blower motor duct increases and the blower duct terminates in a flattened portion in which a length of the flattened portion substantially parallel to a ground surface is substantially greater than a height of the flattened portion which is substantially perpendicular to the ground surface.

6. The pet feces removal device of claim 1 wherein the net frame assembly includes a circumferential loop frame.

7. The pet feces removal device of claim 6 wherein a stub piece is attached to the circumferential loop frame wherein the stub piece and the extended handle each have a socket fit to the coupling.

8. The pet feces removal device of claim 3 wherein the blower motor powers one of an impeller, a fan blade or a compressor wheel, the one of the impeller, a fan blade or a compressor wheel capable of discharging compressed air into the blower duct.

9. The pet feces removal device of claim 1 wherein the blower duct includes an upper blower duct and a lower blower duct connected by a quick release cam lever, the quick release cam lever allowing the lower blower duct to be movable relative to the upper blower duct, movement of the lower blower duct relative to the upper blower duct allowing the lower blower duct to be oriented in various orientation relative to the net frame assembly.

10. The pet feces removal device of claim 5 wherein the flattened portion is aligned with the net frame assembly when viewed from a side of the pet feces removal device.

11. The pet feces removal device of claim 7 wherein the stub piece is fixedly connected to the end of the coupling.

12. The pet feces removal device of claim 8 wherein the extended handle is connected to the opposite end of the coupling in a non-destructive removable manner.

13. The pet feces removal device of claim 12 wherein the extended handle is connected to the opposite end of the coupling in the non-destructive removable manner by use of a quick disconnect assembly.

14. The pet feces removal device of claim 13 wherein the quick disconnect assembly includes a leaf spring attached to the extended handle with a detent located proximal an end of the leaf spring.

15. The pet feces removal device of claim 14 wherein the detent located proximal an end of the leaf spring is inserted through one of a plurality of holes in the coupling.

16. The pet feces removal device of claim 14 wherein the net is formed of a mesh material.

17. The pet feces removal device of claim 15 wherein the net frame assembly, the stub piece and the coupling are capable of being removed from and reinstalled to the extended handle in a non-destructive manner.

18. The pet feces removal device of claim 1 wherein the blower duct has a tapered portion, the tapered portion becoming narrower as the distance from the blower motor assembly becomes greater and the end of the blower duct terminates in a flattened portion.

19. A pet feces removal device comprising:
a blower motor assembly;
an extended handle extending in a direction away from the blower motor assembly;
a blower duct extending in a direction away from the blower motor assembly;
wherein the direction the extended handle extends and the direction that the blower duct extends are substantially parallel.

20. A pet feces removal device comprising:
a blower motor assembly;
an extended handle extending in a direction away from the blower motor assembly;
a blower duct extending in a direction away from the blower motor;
wherein the blower motor duct includes a tapered portion and a flattened portion, the tapered portion becoming narrower in cross-section as the distance from the blower motor duct increases and the blower duct terminates in a flattened portion in which a length of the flattened portion substantially parallel to a ground surface is substantially greater than a height of the flattened portion which is substantially perpendicular to the ground surface.
